(19) United States
(12) Patent Application Publication
(10) Pub. No.: US 2026/0203859 A1
(43) Pub. Date: Jul. 16, 2026

(54) SYSTEM AND METHOD FOR IMAGE RECONSTRUCTION USING STRUCTURED ILLUMINATION THERAPY

(71) Applicant: National University of Singapore, Singapore (SG)

(72) Inventor: Nanguang Chen, Singapore (SG)

(21) Appl. No.: 19/138,259

(22) PCT Filed: Dec. 20, 2023
(86) PCT No.: PCT/SG2023/050848

§ 371 Date: Jun. 12, 2025

(30) Foreign Application Priority Data
Dec. 27, 2022 (SG) 10202260590R

(51) Int. Cl. G06T 5/10; G02B 21/00; G06F 17/16; G06T 3/4084; G06T 5/20; G06T 5/80

(52) U.S. Cl. CPC G06T 5/10; G02B 21/008; G06F 17/16; G06T 3/4084; G06T 5/20; G06T 5/80; G06T 2207/10056; G06T 2207/10064; G06T 2207/20048; G06T 2207/30004

(57) ABSTRACT

In a described embodiment, a method for image reconstruction is implemented including acquiring a set of raw images corresponding to a plurality of phases of illumination patterns. 5 The image reconstruction method further includes using an inverse matrix to separate the raw spectrum of each of the raw images into a baseband spectrum and at least two modulation-shifted spectra and demodulating the set of raw images to generate a demodulated image. A high-pass filter is applied to the baseband spectrum and a low-pass filter is applied to a spectrum of the demodulated image in order to generate a corrected 10 baseband spectrum. The corrected baseband spectrum is combined with the at least two modulation-shifted spectra to generate a synthesized spectrum. Inverse Fourier transform is performed on the synthesized spectrum to produce a reconstructed image.

### TECHNICAL FIELD

The present application pertains generally to methods and systems for optical microscopy, and in particular using structured illumination microscopy for super-resolution imaging and image reconstruction.

### BACKGROUND

Fluorescence microscopy, a fundamental tool in biological research, is commonly used for observing cellular and tissue morphology and processes. The widespread utilization of fluorescence microscopy is largely due to its molecular specificity, high sensitivity, and capacity to resolve subcellular details. In the field of fluorescence microscopy, two primary categories have emerged: wide-field fluorescence microscopes and laser scanning microscopes.

Wide-field fluorescence microscopy is known for its simple implementation and rapid imaging capabilities. It employs a constant and homogeneous illumination pattern and captures images instantaneously using a two-dimensional image sensor. However, the application of wide-field fluorescence microscopy is generally limited to thin samples, such as cultured cells or thinly sliced tissues. The limitation arises from the inability to discriminate between in-focus and out-of-focus fluorescence photons in thicker samples. This leads to blurring of in-focus information by the out-of-focus background, indicating a lack of optical sectioning ability in standard wide-field fluorescence microscopy, making it unsuitable for complex three-dimensional biological samples.

In contrast, laser scanning microscopy, including point-scan and line-scan confocal microscopy (LSCM), has emerged as a more suitable option for thick tissue imaging. These microscopes use a condensed illumination pattern, scanned across the field of view, with a spatial filter like a pinhole or slit to reject unwanted background photons. Point-scan confocal microscopy, in particular, offers effective suppression of out-of-focus light, achieving decent optical sectioning. Nonetheless, point-to-point scanning, is inherently time-consuming, typically limiting imaging speed to a few hertz and more prone to photobleaching and photodamage to samples. Conversely, LSCM, with its line illumination approach, offers increased imaging speed but at the cost of reduced optical sectioning capability and contrast, primarily due to significant background photon leakage through the confocal slit.

Recent advancements in wide-field fluorescence microscopy have introduced techniques like Structured Illumination Microscopy (SIM) and Selected Plane Illumination Microscopy (SPIM), which are effective for optical sectioning in thin and transparent samples. These methods maintain the high-speed imaging and low photobleaching characteristics of traditional wide-field microscopy, with SIM being recognized for its ease of implementation and minimal sample preparation requirements. SIM utilizes a high-frequency structured light pattern projected onto the sample. This pattern attenuates quickly with increasing defocus, allowing only the structures in the focal plane to be significantly modulated. This attribute facilitates the differentiation of targeted signals from unstructured background emissions through computational image processing. The evolution of Optical Sectioning SIM (OS-SIM) has further refined this process by reducing the number of raw images required for effective reconstruction.

However, current SIM techniques face significant challenges when used for complex or thick biological tissue. In these scenarios, a large number of background photons reach the image sensor, which seriously hinders the accuracy of image reconstruction. These background photons overload the sensor, causing higher noise levels and amplifying artefacts in the images due to inaccuracies in the image reconstruction mathematical model. Accordingly, as the depth of imaging increases, the quality of the images deteriorates quickly.

Therefore, it is desirable to provide a method and system that combines spatial filtering with structured illumination for achieving super-resolution imaging and image reconstruction to address the disadvantages or limitations of the existing art or, at the very least, provide the public with a useful alternative.

### SUMMARY

The present disclosure aims to provide new and useful methods and systems for optical microscopy, and in particular to employing structured illumination and spatial filtering for super-resolution imaging and image reconstruction.

In broad terms, the present disclosure proposes a microscopy system including an illumination enabling light source configured to transmit a light beam, an optical unit configured to separate the light beam into a plurality of light beams in a focal plane for generating a plurality of illumination patterns, and a focusing lens configured to focus the plurality of light beams along a first direction to form a focal line on a sample. The microscopy system may include a scanning module comprising one or more scanning mirrors for scanning the focal line across the sample along a second direction and an emission collection mirror for rescanning corresponding fluorescence emissions from the sample. One way of implementing this system is to include a confocal slit for filtering out-of-focus light associated with the fluorescence emissions from the sample for providing filtered fluorescence emissions. As it can be appreciated from the described embodiment, the microscopy system may include a detection unit for acquiring a plurality of images of the sample corresponding to the filtered fluorescence emissions.

In particular embodiments, the microscopy system may include an image processor for reconstructing a high-resolution image representative of a sample based on a combination of a set of captured raw images corresponding to illumination patterns of three phases.

In implementations, the reconstruction of the high-resolution image representative of the sample may include separating frequency components of the raw images, adjusting a rescan ratio along a scanning direction for obtaining one or more reconstructed raw images, and restoring the rescan ratio of the reconstructed raw images along the scanning direction.

In some embodiments, the reconstruction of the high-resolution image representative of the sample may be achieved without rotation of the plurality of the illumination patterns.

In implementations, the sample may be a biological tissue specimen.

In some embodiments, the scanning module may be implemented in the form of two galvo mirrors operated in synchronization for the scanning the sample and rescanning the fluorescence emission over the image sensor.

In implementations, the optical unit may include a retarder for adjusting a polarization component of at least one of the separated light beams for generating the plurality of illumination patterns with adjusted modulation depth.

The optical unit may include a waveplate for adjusting a polarization distribution of the light beam such that the light beam is suitable for separation into the plurality of light beams.

In implementations, the optical unit may include an electro-optic modulator for phase shifting a separated light beam relative to another separated light beam.

In embodiments, the focusing lens may be a cylindrical lens and the first direction may be orthogonal to the second direction.

In implementations, the plurality of illumination patterns may be generated based on a detected interference between the plurality of separated light beams.

In particular embodiments, the confocal slit may be fixed in angular position or direction.

The optical unit may include a Wollaston prism for separating the light beam into the plurality of light beams, wherein a separation angle of the Wollaston prism is determined.

The microscopy system may include determining a modulation frequency corresponding to the Wollaston prism based upon an image resolution and a signal-to-noise ratio.

In implementations, the confocal slit may be optically conjugated with the focal line for filtering out-of-focus light.

In embodiments, the detection unit may include a scientific complementary metal-oxide-semiconductor (CMOS) camera that is synchronized with the one or more scanning mirrors and the emission collection mirror for implementing a one-dimensional image rescan.

The scanning module may be configured to increase the angular velocity of the one or more scanning mirrors relative to the emission collection mirror to achieve a predetermined rescan ratio optimal for resolution enhancement.

In broad terms, the present disclosure proposes a light microscopy method which may include transmitting a light beam, separating the light beam into a plurality of light beams in a focal plane for generating a plurality of illumination patterns, and focusing the plurality of light beams along a first direction to form a focal line on a sample. The light microscopy method may include scanning the focal line across sample along a second direction and rescanning corresponding fluorescence emissions from the sample, filtering out-of-focus light associated with the fluorescence emissions from the sample for providing filtered fluorescence emissions, and acquiring a plurality of images of the sample corresponding to the filtered fluorescence emissions.

The present disclosure further proposes a method for image reconstruction including acquiring a set of raw images corresponding to a plurality of phases of illumination patterns and applying a Fourier transform (FT) to each of the raw images in the acquired set to obtain a corresponding raw spectrum for each of the raw images. One way of employing this image reconstruction method includes using an inverse matrix to separate the raw spectrum of each of the raw images into a baseband spectrum and at least two modulation-shifted spectra and demodulating the set of raw images to generate a demodulated image. As it can be appreciated from the described embodiment, the image reconstruction method may include applying a plurality of high-pass filter to the baseband spectrum and a low-pass filter to a spectrum of the demodulated image in order to generate a corrected baseband spectrum, combining the corrected baseband spectrum with the at least two modulation-shifted spectra to generate a synthesized spectrum, and performing an inverse Fourier transform on the synthesized spectrum to produce a reconstructed image.

The image reconstruction method may include resizing the reconstructed image to correct for aspect ratio distortion resulting in the reconstructed image having a reduced horizontal dimension.

The demodulation of the set of raw images may include suppressing out-of-focus light and system bias from the raw images, wherein the system bias includes camera dark current.

In implementations, the phases of the illumination patterns may include 0 degrees, 120 degrees, and 240 degrees.

In embodiments, the corrected baseband spectrum may be generated by adding the high-pass filtered baseband spectrum to the low-pass filtered spectrum of the demodulated image, wherein the high-pass filter and the low-pass filter use the same predetermined cut-off frequency.

The demodulated image may correspond to a standard-resolution image and the generated synthetized spectrum comprises a frequency range extended in a vertical direction.

In implementations, the resizing step may be executed based on a rescan ratio of two, thereby achieving super-resolution along at least a horizontal direction of the reconstructed image.

Embodiments described herein may thereby provide a method and system for structured illumination microscopy and image rescan, resulting in one or more of the following advantages:

Reducing background photons in deep tissue imaging by integrating a confocal slit, which lessons shot noise and laser intensity noise.

Enhancing image acquisition by eliminating the need to rotate a modulated illumination pattern for multiple angular orientations.

Achieving super-resolution in both lateral directions by adapting an image rescan technique to a line-scan configuration and integrating both with structured illumination microscopy.

Maintaining high image quality and resolution at higher imaging depths by effectively addressing background fluorescence emission issues commonly encountered in deep tissue imaging.

Enhancing spectral accuracy and reducing background effects based on the assumption that background is typically dominated by low-frequency components and is independent of modulation phase.

The above description is provided as an overview of some implementations of the present disclosure. Further description of those implementations, and other implementations, are described in more detail below.

### BRIEF DESCRIPTION OF THE DRAWINGS

Embodiments of the invention will now be explained for the sake of example only, with reference to the following figures in which:

FIG. 1 is a schematic representation of a confocal rescan structured illumination microscope (CR-SIM) system, according to an embodiment herein.

FIG. 2A is an optical diagram illustrating an image formation of a point object with normal scan (n=1) and image rescan (n=2) configurations, according to an embodiment herein.

FIG. 2B is a graphical representation comparing point spread function (PSF) widths for the normal scan (n=1) and the image rescan (n=2) configurations, according to an embodiment herein.

FIG. 3A is a graphical representation of simulated PSFs for various slit sizes, according to an embodiment herein.

FIG. 3B is a graphical representation of simulated optical transfer functions (OTFs) for various slit sizes, according to an embodiment herein.

FIG. 4 is a schematic representation of an optical path and computational workflow used in CR-SIM image reconstruction, according to an embodiment herein.

FIG. 5 is a flowchart illustrating high-level processing steps of the image reconstruction process of FIG. 4, according to an embodiment herein.

FIG. 6A is an image capture of 100 nm florescence beads using a Laser Scanning Confocal Microscopy (LSCM) system, according to an embodiment herein.

FIG. 6B is an image capture of the 100 nm fluorescent beads using the CR-SIM system, according to an embodiment herein.

FIG. 6C is a processed image of the 100 nm fluorescent beads shown in FIG. S3B after undergoing Richardson-Lucy deconvolution with 10 iterations, according to an embodiment herein.

FIG. 6D is a graphical representation comparing intensity profiles along vertical and horizontal lines through the centre of the fluorescent bead as captured in FIGS. 6A-6C, according to an embodiment herein.

FIG. 7 is a comparative set of fluorescence microscopy images at varying focal depths (0, 250, and 500 μm) within a thick-tissue phantom, using WF-SIM, LSCM, and CR-SIM, according to an embodiment herein.

FIG. 8A is a graphical representation of signal-to-background ratio (SBR) as a function of depth for fluorescent beads imaged by WF-SIM, LSCM, and CR-SIM according to an embodiment herein.

FIG. 8B is a graphical representation of signal-to-noise ratio (SNR) as a function of depth for fluorescent beads imaged by WF-SIM, LSCM, and CR-SIM, according to an embodiment herein.

FIG. 9 are three-dimensional volumetric renderings of thick beads phantom showing fluorescence intensity distribution as imaged by Wide-field Structured Illumination Microscopy (WF-SIM), LSCM, and CR-SIM, according to an embodiment herein.

FIG. 10A is an image capture of fixed Hela cells identifying F-actin structures using LSCM, according to an embodiment herein.

FIG. 10B is an image capture of the same identified F-actin structures within the fixed HeLa cells as shown in FIG. 10A, but imaged using CR-SIM, according to an embodiment herein.

FIG. 10C is a graphical representation comparing normalized intensity profiles of the F-actin structures along the identified regions in FIGS. 10A and 10B, according to an embodiment herein.

FIG. 10D is a magnified view of the F-actin structures identified in FIG. 10A using LSCM, according to an embodiment herein.

FIG. 10E is a magnified view of the F-actin structures identified in FIG. 10B using CR-SIM, according to an embodiment herein.

FIG. 11A is a volumetric rendering of a CR-SIM image stack of a Thy1-EGFP transgenic mouse brain slice, according to an embodiment herein.

FIG. 11B is a comparative image showing a side-by-side visualization of a neuron soma atZ=23 μm using both LSCM (left) and CR-SIM (right) systems, according to an embodiment herein.

FIG. 11C is an enlarged view of a 2.4 μm×2.4 μm region of the neuron soma center, as captured by the CR-SIM system in FIG. 11B, according to an embodiment herein.

FIG. 11D is a graphical representation of intensity profiles along the horizontal and vertical lines within the region shown in FIG. 11C, according to an embodiment herein.

FIG. 11E is a three-dimensional rendering view of a partial volumetric scan of a mouse brain tissue section, obtained by CR-SIM, according to an embodiment herein.

FIGS. 11F-11H are image captures of neuronal structures within a Thy1-EGFP transgenic mouse brain slice at varying depths of 113 μm (FIG. 11F), 132 μm (FIG. 11G), and 197 μm (FIG. 11H), using the CR-SIM system, according to an embodiment herein.

FIGS. 11I-11K are magnified image captures corresponding to regions in FIGS. 11F-11H, of the same Thy1-EGFP transgenic mouse brain slice, magnified by a factor of 4, according to an embodiment herein.

### DETAILED DESCRIPTION

Embodiments will now be discussed with reference to the accompanying FIGS., which depict one or more exemplary embodiments. These embodiments are described in sufficient detail to enable those skilled in the art to practice the embodiments and it is to be understood that mechanical, logical, and other changes may be made without departing from the scope of the embodiments. Therefore, embodiments may be implemented in many different forms and should not be construed as limited to the embodiments set forth herein, shown in the FIGS., and/or described below.

Unless otherwise defined, all terms (including technical and scientific terms) used herein are to be interpreted as is customary in the art. It will be further understood that terms in common usage should also be interpreted as is customary in the relevant art.

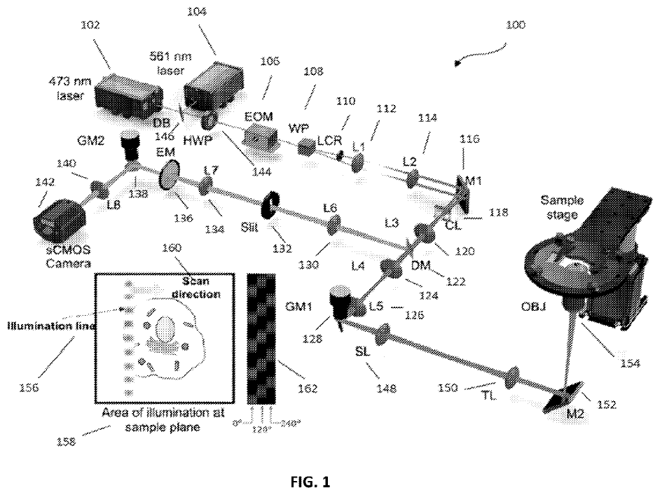

FIG. 1 is a schematic representation of a confocal rescan structured illumination microscope (CR-SIM) system 100, according to an embodiment herein.

### Laser Excitation

In implementations, CR-SIM system 100 may include illumination enabling light source corresponding to a 473 nm laser 102 and a 561 nm laser 104 configured to transmit light beams for a sample's illumination.

CR-SIM system 100 may include optical units such as a Wollaston prism (WP) 108, an electro-optic modulator (EOM) 106, a liquid crystal retarder (LCR) 110, and a half-wave plate (HWP) 144. These optical units manipulate the properties of the light beam in preparation for the imaging process.

### Beam Preparation

Light from the lasers 102 and 104 may be manipulated by various optical components, such as a dichroic beam splitter (DB) 146, which directs the combined the laser beam towards the sample, and spherical lenses (L1-L8) 112, 114, 120, 124, 126, 130, 134, and 140 which collimate or focus the light beams.

### Polarization:

A half-wave plate (HWP) 144 and a liquid crystal retarder (LCR) 110 may adjust the polarization of the light, necessary for proper functioning of subsequent components of system 100 like a Wollaston prism (WP) 108.

### Structured Illumination:

The Wollaston prism (WP) may split the laser beam into two polarized beams that may then further condensed by a cylindrical lens (CL) 118. The CL may serve as a focusing lens which focuses the separated light beams along one direction to form a focal line on the sample.

These beams may be further directed towards an objective lens (OBJ) 154, where they converge to create an interference pattern—the structured illumination on the sample.

### Phase Modulation:

An electro-optic modulator (EOM) 106 may dynamically shifts the phase of the structured illumination, which is essential for the SIM process.

### Scanning:

Scan lens (SL) 148 may further focus the laser beams to form a line on the sample stage. The scan lens (SL) may be configured to operate in conjunction with two separate scanning modules (GM1 and GM2) 128 and 138 to facilitate proper scanning of the beam across the sample. In embodiments, the scanning modules 128 and 138 may correspond to galvo mirrors which are configured to scan the line of structured light across the sample. The first galvo mirror (GM1) 128 may adjust the position of the excitation line, and the second galvo mirror (GM2) 138, synchronized with the GM1 128, may implement a rescan of the sample at a different velocity.

### Florescence Emission and De-Scanning:

The sample emits fluorescence upon excitation, collected by the objective lens (OBJ) 154. The emitted light is de-scanned by GM1 128, meaning it reverses the path of the scanning motion to stabilize the image.

A tube lens (TL) 150 may relay the de-scanned fluorescence light, focusing it properly for imaging.

### Emission Pathway:

The fluorescence may be passed back through the OBJ 154 and is reflected by a dichroic mirror (DM) 122 towards detection optics of sCMOS camera 142. An emission filter (EM) 136 may selectively allow only the fluorescence signal to pass, filtering out the excitation wavelength.

### Confocal Detection:

The fluorescence light passes through a confocal slit 132 to further reject out-of-focus light. The confocal slight 132 provide filtered emissions which enhances image contrast and resolution, especially in thick tissues.

The filtered fluorescence light is finally captured by a detection unit such as the sCMOS camera 142, which converts the light into an electrical signal that can be processed into an image.

### Image Acquisition and Processing:

The captured images, which include the structured illumination pattern at various phase shifts, are processed computationally to reconstruct a high-resolution image of the sample, with improved contrast, ideal for thick tissue samples.

### Lenses and Mirrors:

Focusing lens for forming a focal line may include the spherical lenses (L1-L8) 112, 114, 120, 124, 126, 130, 134, and 140 with specified focal lengths are used to shape and focus the light paths for both excitation and emission. Additional mirrors (M1 and M2) 116 and 152 may be used to direct the light appropriately through system 100.

In implementations, an illumination line 156 is employed as a specific form of the excitation light as it interacts with the sample. In examples, the area of illumination 158 may include a region of the sample that is being illuminated by the illumination line 156 at a given moment. The area of illumination 156 may include an area where the illumination line 156 interacts with the sample to excite the fluorescent markers within that specific region. Scan direction 160 may correspond to a direction in which the illumination line 156 moves across the sample. A scanning mechanism is responsible for moving the line illumination 156 across the sample plane to systematically excite different regions, enabling the entire area of a sample of interest to be imaged over time.

Multiple images may be captured at different phase shifts 162 (e.g., 0, 120, and 240 degrees). These phase shifts change the position of the light and dark stripes in the pattern. By capturing images at different phases and combining them, the microscope can reconstruct an image with higher resolution than would be possible with a single phase.

In example implementations of the CR-SIM system 100, the second galvanometer mirror (GM2) is adjusted to operate at an increased angular velocity, defined by a rescan ratio n, compared to the first galvanometer mirror (GM1). As mentioned above, an optimal resolution enhancement is achieved when n is set to 2. A detailed explanation of one-dimensional image re-scanning using a slit, as well as a comparative analysis of system behaviour for rescan ratios of 1 and 2, is set out below.

### Principle of One-Dimensional Image Re-Scan

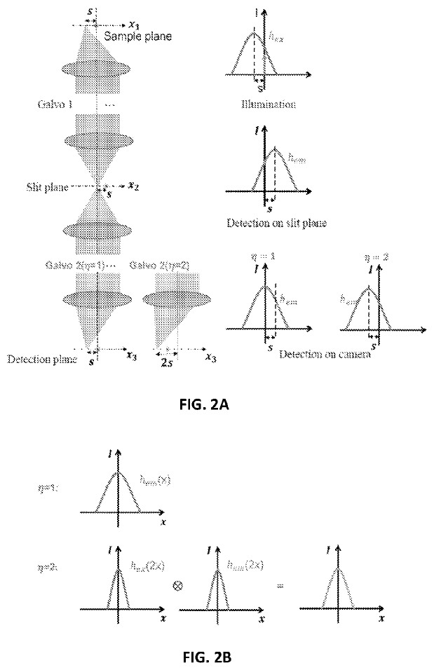

To intuitively illustrate the image re-scan principle in one dimension, the formation of the point spread function is described using a simplified optical system, as shown in FIGS. 2A and 2B. FIG. 2A is an optical diagram illustrating an image formation of a point object with normal scan (n=1) and image rescan (n=2) configurations, according to an embodiment herein. The left side of FIG. 2A shows a light path of the imaging process in the case that a line focus is scanned to an offset of s from the origin for each of a sample plane, a slit plane, and a detection plane. The right side of FIG. 2A plots the corresponding illumination or detection intensity profiles at each of the planes. FIG. 2B is a graphical representation comparing point spread function (PSF) widths for the normal scan (n=1) and the image rescan (n=2) configurations, according to an embodiment herein.

The imaging system may be modelled using two 4f systems, comprising the sample plane (x1), the intermediate slit plane (x₂), and the detection plane (x₃). For the sake of simplicity, it's assumed that all optical magnifications are 1. The diffraction-limited field point spread functions for fluorescence excitation and emission are denoted as hₑₓ(x) and hₑₘ(x) respectively. These field point spread functions are calculable through the Debye integral, particularly in scenarios involving a cylindrical lens:

$$h ( v ) = {\int }_{pupil}^{d} P ( ξ ) exp ( - iv ξ ) d ξ ,$$

where P(ξ) is the pupil function and the coordinate ξ the transverse displacement in the pupil plane, normalized by the pupil size from −1 to 1. v is the optical coordinates given by v=2πN A·x/λ.

To obtain the system point spread function, a fluorescent point object at the origin of the sample plane is positioned, which can be expressed as δ(x₁). When the illumination line focus is scanned to an offset distance s from the origin, the excitation field point spread function at the sample plane is simply hₑₓ(x₁+s). Without loss of generality, the fluorescence quantum yield is assumed to be 1. Therefore, the emission field from the object is given by

$${E}_{1} ( {x}_{1} , s ) = \vert {h}_{ex} ( {x}_{1} + s ) \vert δ ( {x}_{1} )$$

The emission field is de-scanned by the first scanner (GM1) and propagates to the slit plane. Its distribution can be represented by |hₑₓ(s)|hₑₘ(x₂−s), which has its center shifted by s from the origin. A slit can be placed at the slit plane as a spatial filter.

In this optical system, the modulation direction is aligned parallel to the slit. This parallel orientation plays a role in the effectiveness of the slit as a spatial filter, impacting the overall quality and resolution of the image reconstruction process.

For a finite size slit, its aperture can be modelled by a piecewise function:

$$D ( {x}_{2} ) = \{ \begin{matrix}1 , & \vert {x}_{2} \vert \leq d \\ 0 , & \vert {x}_{2} \vert > d\end{matrix} .$$

where 2d is the slit width. The emission field passing through the slit is simply:

$${E}_{2} ( {x}_{2} , s ) = \vert {h}_{ex} ( s ) \vert {h}_{em} ( {x}_{2} - s ) D ( {x}_{2} )$$

This emission intensity is then rescanned by the second scanner (GM2) and mapped to the detection plane. Its distribution is also determined by hₑₘ and but shifted by s′, an offset depending on the angular amplitude of GM2 which may be different from that of GM1.

Here we define a sweep factor (rescan ratio) η so that s′=ηs. Consequently, the instantaneous field distribution in the detection plane is given by:

$${E}_{3} ( {x}_{3} , s ) = \int d {x}_{2} {E}_{2} ( {x}_{2} ) {h}_{em} ( {x}_{3} + {x}_{2} - {s}^{′} ) = \int {dx}_{2} \vert {h}_{ex} ( s ) \vert {h}_{em} ( {x}_{3} + {x}_{2} - {s}^{′} ) {h}_{em} ( {x}_{2} - s ) D ( {x}_{2} )$$

The intensity point spread function at the detection plane can be obtained by the integration over s:

$${I}_{3} ( {x}_{3} ) = \int ds {\vert {E}_{3} ( {x}_{3} , s ) \vert}^{2} = \int ds {\vert {h}_{e x} ( s ) \vert}^{2} {\vert \int {dx}_{2} {h}_{em} ( {x}_{3} + {x}_{2} - {s}^{′} ) {h}_{em} ( {x}_{2} - s ) D ( {x}_{2} ) \vert}^{2}$$

Consider further two extreme scenarios. If an infinitesimally narrow slit is employed, the slit function is equivalent to a delta function, denoted as δ(x₂). Under these conditions, the equation for I₃(x₃) simplifies to the following form:

$${l}_{3} ( {x}_{3} ) = \int ds {\vert {h}_{e x} ( s ) \vert}^{2} {\vert {h}_{em} ( s ) \vert}^{2} {\vert {h}_{em} ( {x}_{3} - η s ) \vert}^{2} = \frac{1}{η} {PSF}_{c} ( \frac{{x}_{3}}{η} ) ⊗ {PSF}_{w} ( {x}_{3} ) ,$$

where ⊗ denotes the convolution operation. PSF_{c} and PSF_{w} are diffraction limited confocal point spread function and wide-field point spread function, respectively.

If no slit is used, the slit function becomes a constant (D(x₂)=1). Then we define s″=(η−1) s so that the equation for I₃(x₃) can be rewritten as:

$${I}_{3} ( {x}_{3} ) = \int {\vert {h}_{e x} ( s ) \vert}^{2} {\vert {h}_{em} ( {x}_{3} - ( η - 1 ) s \vert}^{2} ds = \frac{1}{η - 1} \int {\vert {h}_{e x} ( \frac{{s}^{″}}{η - 1} ) \vert}^{2} {\vert {h}_{em} ( {x}_{3} - {s}^{″} ) \vert}^{2} {ds}^{″} = {\vert {h}_{ex} ( \frac{{x}_{3}}{η - 1} ) \vert}^{2} ⊗ {\vert {h}_{em} ( {x}_{3} ) \vert}^{2}$$

This detection plane PSF can be mapped back to the sample plane and it becomes:

$${I}_{1} ( {x}_{1} ) = {\vert {h}_{e x} ( \frac{η}{η - 1} {x}_{1} ) \vert}^{2} ⊗ {\vert {h}_{em} ( {η x}_{1} ) \vert}^{2}$$

When n=1, the system works in the normal scan mode where the intensity point spread function is reduced to |hₑₘ(x₁)|², which is equivalent to PSF_{w}. In the case of η>1, the system PSF is the convolution of two wide-field PSFs, which are compressed by factors of

$$\frac{η}{η - 1}$$

and η, respectively.

As illustrated in FIG. 2B, the best scenario is η=2 when both wide-field PSFs are squeezed equally by two times. Compared to PSF_{w}, the FWHM (full width at half maximum) of I₁(x₁) is improved by a factor of about 1.5 in this case.

Further numerical investigation was conducted on the system behaviour when the slit size is finite and the rescan ratio is maintained at η=2.

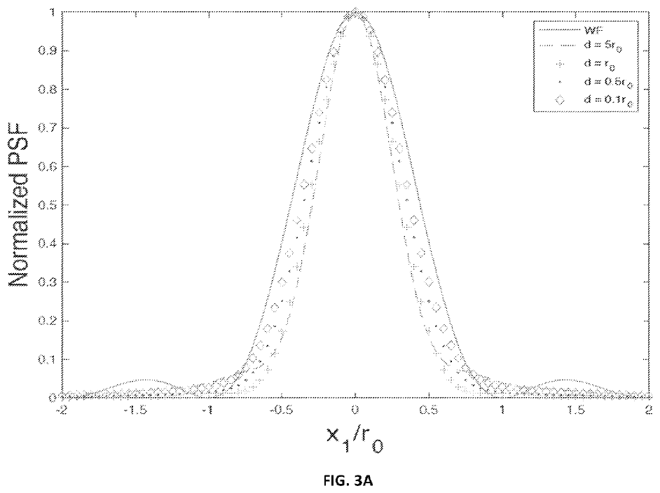

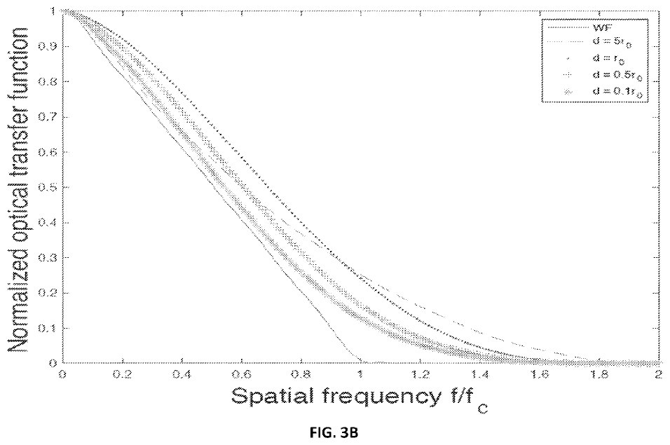

FIG. 3A is a graphical representation of simulated PSFs for various slit sizes, according to an embodiment herein. The coordinates x₁ is normalized to r₀=0.61λ/NA. The PSF_{w} is also plotted in the same figure for comparison. The PSF FWHM of the image rescan system is reduced by factors of 1.17, 1.25, 1.37, and 1.49, respectively, for slit sizes of d=0.1r₀, 0.5r₀, r₀, and 5r₀. The slit size of d=5r₀ results in a resolution enhancement very close to the open slit case, while d=r₀ seems a good compromise between super-resolution and background rejection.

FIG. 3B is a graphical representation of simulated optical transfer functions (OTFs) for various slit sizes, according to an embodiment herein. The OTF of a wide-field system stops at the cut-off spatial frequency f_{c}=1/r₀. In contrast, the spatial frequency band is stretched to 2f_{c} when d=5r₀. It implies that the resolution can be enhanced by a factor of 2 instead of 1.5 if a suitable deconvolution process is followed to reshape the spectrum. For a slit size more relevant to optical sectioning (e.g., d=r₀), a resolution enhancement beyond 1.6 can be readily achieved with the assistance of deconvolution.

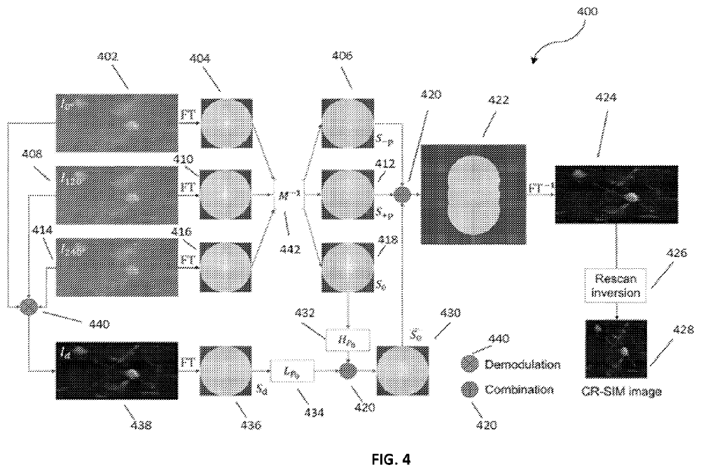

FIG. 4 is a schematic representation of an optical path and computational workflow 400 used in CR-SIM image reconstruction, according to an embodiment herein. FIG. 5 is a flowchart illustrating high-level processing steps of the image reconstruction process 500 of FIG. 4, according to an embodiment herein. In the description that follows, the optical components and computational modules illustrated in FIG. 4 will be referenced in conjunction with the procedural steps outlined in FIG. 5 to explain the functions of the components within the process of CR-SIM image reconstruction. This reconstruction process 500 is crucial for separating and recombining the frequency components shifted by the spatial modulation, enhancing resolution in the modulation direction (i.e. parallel to the confocal slit 132)

In example implementations, the CR-SIM image reconstruction process 500 begins in step 502 with the acquisition of raw images at different illumination pattern phases. In embodiments, the raw images I_{0°} 402, I_{120°} 408, I_{240°} 414 may be captured by a camera for illumination pattern phases of 0 degrees, 120 degrees, and 240 degrees. The raw images 402, 408, and 414 may further stretched in the horizontal direction due to a rescan ratio of η=2.

In step 504, each raw image 402, 408 and 414 may be subjected to a two-dimensional Fourier transform (FT) to convert each image into a corresponding frequency domain 404, 410 and 416, respectively. The application of the FT of the raw images produces in three separate spectral representations.

In example embodiments, a spectrum of raw images corresponding to I₀, (r), I₀_{₂}(r), and I₀, (r) may be linked to a sample spectrum by:

$$[ \begin{matrix}{ℐ}_{{ϕ}_{1}} ( k ) \\ {ℐ}_{{ϕ}_{2}} ( k ) \\ {ℐ}_{{ϕ}_{3}} ( k )\end{matrix} ] = M [ \begin{matrix}𝒮 ( k ) ℋ ( k ) \\ 𝒮 ( k - {P}_{y} ) ℋ ( k ) \\ 𝒮 ( k + {P}_{y} ) ℋ ( k )\end{matrix} ] + N .$$

where [symbol] (k), [symbol] (k), and [symbol] (k) are FTs of the raw images related to the three modulation phases which may correspond to Ø₁=0 degrees, Ø₂=120 degrees, and Ø₃=240 degrees. H(k) represents the optical transfer function (OTF). Py is the spatial frequency of the modulated illumination pattern, M is the modulation matrix, and N denotes random noise.

In embodiments, the actual phases may deviate from the above ideal values (0, 120, and 240 degree) even though the EOM 106 driving voltages have been previously calibrated. As such, an inverse modulation matrix 442 may be employed to estimate the real phase shifts.

In step 506, an inverse modulation matrix M⁻¹ 442 may be employed to retrieve baseband (S₀) 418 and frequency-shifted spectra (S₊ₚ and S₋ₚ) 406 and 412 from the images.

As such, for a best estimate of the OTF weighted sample spectra can be generated by the inverse modulation of matrix M.

However, in thick tissue imaging, the background fluorescence emission from out-of-focus regions is not adequately modelled by the OTF alone. After reconstruction with the above standard algorithm, the background will distort the spectral estimates, especially the baseband spectrum estimate [symbol] (k) [symbol] (k). As a result, the effective resolution and image quality may deteriorate appreciably.

Given that background is dominated by low-frequency components and independent of the modulation phase, it is therefore assumed that the estimated spectra [symbol] (k− [symbol] ) [symbol] (k) and [symbol] (k+ [symbol] ) [symbol] (k) with the above equation for the spatial spectra of the raw images are not significantly biased by the background, which instead concentrates on the centre portion of [symbol] (k) [symbol] (k).

In step 508, a demodulated image (I_{d}) 438 may be obtained by applying a demodulation algorithm 440 to the three raw images 402 408 and 414. This algorithm 440 may correspond to an optical sectioning SIM algorithm which substantially suppresses out-of-focus emission and system bias (such as camera dark current). A FT is applied to the demodulated image 438 to generate a spectrum (S_{d}) 436 of the demodulated image.

In step 510, a high-pass filter 432 may be applied to the baseband component 418 to filter out low-frequency components and a low-pass filter 434 is applied to the spectrum 436 to filter out high-frequency components. In example embodiments, the high-pass 432 and low-pass filters 434 may use the same cut-off frequency of Pₒ for filtering the components.

In step 512, the output of the high-pass filter 432 and the output of the low-pass filter 434 may be combined 420 to produce a corrected baseband spectrum ( [symbol] ) 430. In example embodiments, the combining algorithm 420 involves a low-frequency part of spectrum (S_{d}) 436 being replaced by a corresponding region in baseband (Sₒ) 418 in order to produce the corrected baseband spectrum 430 that is a background-free spectrum.

In an example approach for the demodulation process as provided in steps 508, 510 and 512, a low cutoff frequency P₀ may be empirically chosen to define a circular frequency range, in which the spectrum needs to be corrected. A demodulation method may be used to retrieve the background-free low-frequency content from its frequency-shifted spectra. For example, a demodulated image can be obtained by

$${I}_{d} ( r ) = \sqrt{{( {I}_{{ϕ}_{1}} ( r ) - {I}_{{ϕ}_{2}} ( r ) )}^{2} + {( {I}_{{ϕ}_{2}} ( r ) - {I}_{{ϕ}_{3}} ( r ) )}^{2} + {( {I}_{{ϕ}_{3}} ( r ) - {I}_{{ϕ}_{1}} ( r ) )}^{2}} .$$

In this demodulated image equation, the background is essentially cancelled by the subtraction operations. As such, the corrected version of [symbol] (k) [symbol] (k) is now given by: [symbol] =H_{P}_{ₒ}[ [symbol] (k) [symbol] (k)}+L_{P}_{ₒ}{F[I_{d}(r)]}, where H_{P}_{ₒ} and L_{P}_{ₒ} are high-pass and low-pass filters with the same cut-off frequency of P₀, and F[·] denotes a two-dimensional FT

In step 514, the corrected baseband spectrum 430 may be combined with the frequency-shifted spectra 406 and 412 to create a synthesized spectrum 422 with its frequency range extended in a vertical direction.

In step 516, an inverse FT (FT⁻¹) may be applied to the synthesized spectrum 422 to convert the spectrum 422 back into a spatial domain resulting in a reconstructed image 424.

For example, the above estimated spectra [symbol] , [symbol] (k− [symbol] ) [symbol] (k) and [symbol] (k+ [symbol] ) [symbol] (k) may be combined to form the synthesized spectrum 422 which is used to create a reconstructed SIM image super-resolution along the modulation direction with suppressed background.

In step 518, the reconstructed image 424 may be adjusted to correct for any distortions due to image rescan where proportions of the image may be altered. For example, during super-resolution acquisition of image 424, the rescan ratio may have been set to 2. Consequently, the raw images were stretched by a factor of 2 in the scanning direction (orthogonal to the slit).

In step 518, image 424 may be resized (e.g. shrinking by a factor of 2) in the scanning direction using a rescan inversion technique 426 to restore the original aspect ratio. The rescan inversion 426 may reduce the horizontal dimension of image 424 by one half by applying a rescan inversion 426 with a factor of 2.

In example embodiments, the rescan inversion 426 would effectively double the frequency content of image 424 in the direction of the distortion. This frequency doubling would enhance the resolution of outputted image 428 in that specific direction, contributing to the super-resolution effect of CR-SIM image 428.

### Experimental Results

The following section describes various experiments conducted to evaluate embodiments of the disclosure. Some of these experiments illustrate embodiments of the disclosure other than those discussed above.

### A. Quantitative Validation of CR-SIM

One of the main technical advantages of CR-SIM is its imaging speed. Conventional SR-SIM systems need to acquire at least nine raw images and involve the rotation of the illumination pattern. In contrast, CR-SIM only requires three raw images to reconstruct one super-resolution image. A significantly improved imaging speed is achieved without compromising the image quality. The resolution enhancement offered by CR-SIM has been verified and characterized with 100 nm yellow-green fluorescent beads and using a 60×/1.2 NA OBJ lens. The CR-SIM image resolutions were measured at 175 and 179 nm in the horizontal and vertical directions, respectively, which were 1.47 to 1.51 times better than the diffraction limit. After Richardson-Lucy deconvolution, the resolution improvement could reach 1.93 to 1.99 times, as further detailed below with respect to spatial resolution enhancement characterized by florescent beads.

### Spatial Resolution Enhancement Characterized by Fluorescent Beads

The lateral resolution of the CR-SIM system was characterized using 100 nm fluorescent beads, employing a bandpass (20 nm bandwidth) filter centered at 520 nm for emission filtering. To verify the high-resolution performance, a water-immersion objective lens with a high numerical aperture (NA) of 1.2 and a high magnification of 60× (UPlanSApo 60×/1.20W, Olympus) was used for the imaging experiment.

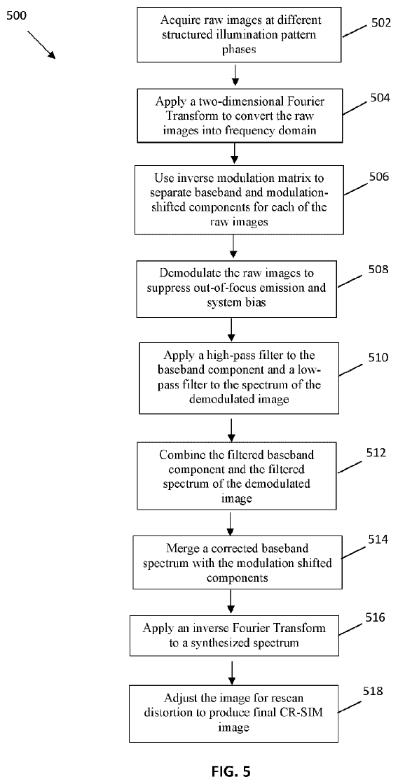

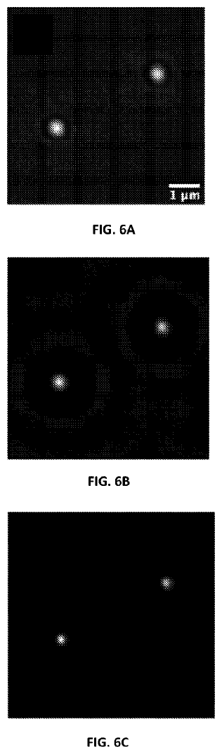

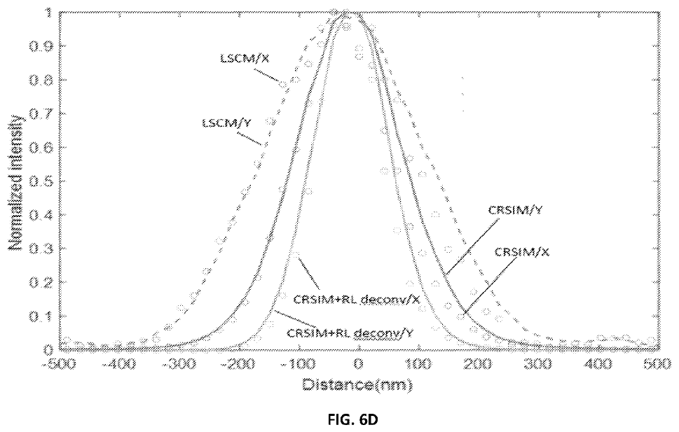

FIG. 6A is an image capture of 100 nm florescence beads using a Laser Scanning Confocal Microscopy (LSCM) system, according to an embodiment herein. FIG. 6B is an image capture of the same 100 nm fluorescent beads using the CR-SIM system, highlighting differences in imaging quality, according to an embodiment herein. FIG. 6C is a processed image of the 100 nm fluorescent beads shown in FIG. 6B after undergoing Richardson-Lucy deconvolution with iterations, according to an embodiment herein. This deconvolution parameter was selected to achieve the highest resolution improvement and at the same time avoid overamplification of the noise that leads to the ringing artifacts FIG. 6D is a graphical representation comparing intensity profiles along vertical (Y) and horizontal (X) lines through the centre of the fluorescent bead as captured in FIGS. 6A-6C, according to an embodiment herein. Spatial resolutions measured from LSCM beads images were 291 nm in the horizontal direction and 294 nm in the vertical direction. In contrast, the CR-SIM image resolutions were 175 nm and 179 nm, respectively, in horizontal and vertical directions. The resolution improvement was 1.64-1.66× over LSCM and 1.47-1.51× over the diffraction limit. After deconvolution, the resolution improvement was 1.93-1.99× over the diffraction limit, which is nearly double the resolution band limit.

Another essential technical improvement of CR-SIM is its strong optical sectioning capability, which is desirable for deep-tissue imaging. The fixed orientation of the illumination pattern makes it possible to include a slit to block a substantial amount of background emissions. This physical spatial filter, coupled with additional background rejection afforded by the CR-SIM reconstruction algorithm, leads to an outstanding signal-to-background ratio (SBR) and signal-to-noise ratio (SNR).

A thick-tissue phantom made of 2-μm fluorescence beads in 2% lipid emulsion was used for quantifying these two specifications. The phantom was scanned three-dimensionally with CR-SIM, LSCM, and WF-SIM from the surface down to 500 μm in depth at an increment of 1 μm, using a 20×/0.95 NA (XLUMPLFLN, Olympus) OBJ lens. To simplify the comparison, the WF-SIM images were acquired using the same CR-SIM imaging platform but with the slit wide open. For a fair comparison, the exposure time for each raw image of WF-SIM/CR-SIM was set to 100 ms, whereas the exposure time for LSCM image was set to 300 ms. Image acquisition time of the whole volumetric stack was 200s.

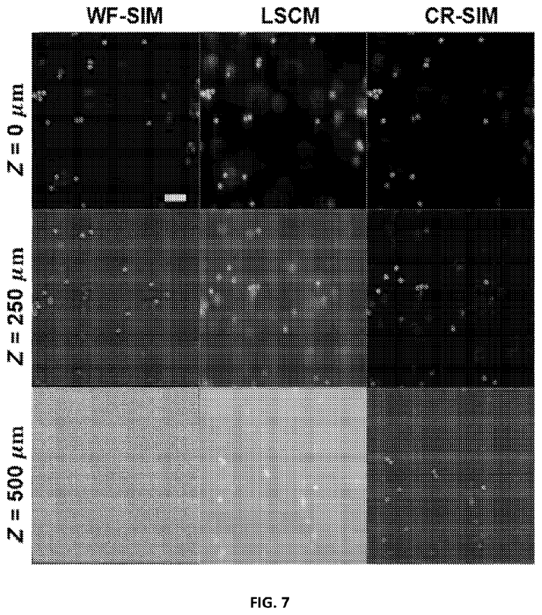

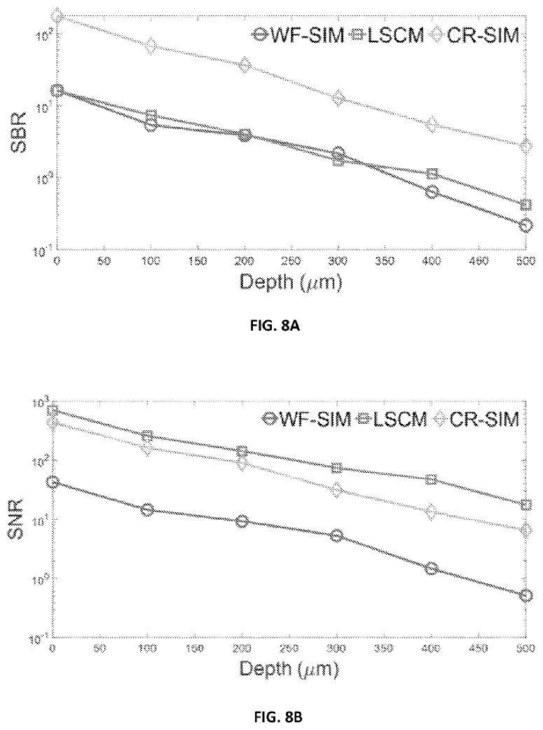

FIG. 7 is a comparative set of fluorescence microscopy images at varying focal depths (0, 250, and 500 μm) within a thick-tissue phantom, using WF-SIM, LSCM, and CR-SIM, according to an embodiment herein. FIG. 8A is a graphical representation of signal-to-background ratio (SBR) as a function of depth for fluorescent beads imaged by WF-SIM, LSCM, and CR-SIM according to an embodiment herein. FIG. 8B is a graphical representation of signal-to-noise ratio (SNR) as a function of depth for fluorescent beads imaged by WF-SIM, LSCM, and CR-SIM, according to an embodiment herein. The SBR and SNR values of the beads imaged by WF-SIM, LSCM, and CR-SIM are measured across a depth range extending from the surface to 500 μm.

The imaging data presented in FIG. 7 and FIGS. 8A and 8B suggested that WF-SIM, obtained with a reconstruction algorithm enabling optical sectioning, was able to remove a similar amount of low-frequency background as LSCM did, and both provided closely matched SBR. However, the computational approach failed to suppress the random noises associated with the background, which could be more effectively eliminated by a physical slit. At the depth of 500 μm, microbeads could hardly be differentiated from the noisy background in the WF-SIM image. On the other hand, they are still visible in the LSCM image, even though the contrast was rather low and the effective resolution was very poor. As the CR-SIM technique combined two background rejection mechanisms together, the SBR was further improved by roughly 20 dB over the entire depth range. It was striking that the SBR for CR-SIM at the depth beyond 300 μm could match those of WF-SIM and LSCM at the surface. In addition, CR-SIM also inherited the strong noise reduction afforded by the slit integrated into the system. Although its SNR was slightly lower than that of LSCM due to the modulation and demodulation losses, it was approximately enhanced by 8.9 to 19.6 dB over WF-SIM.

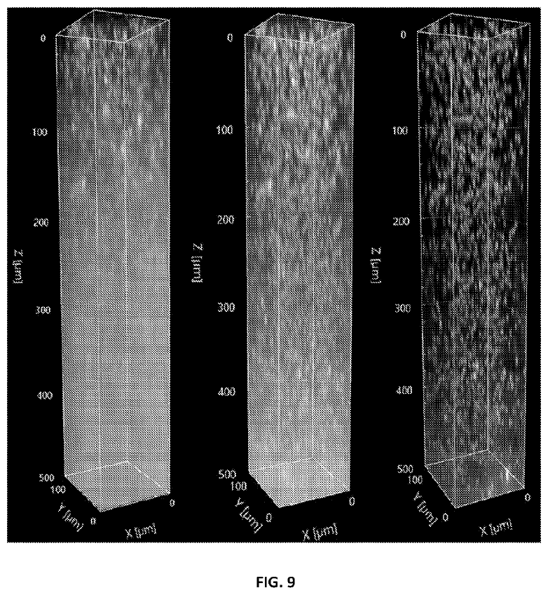

FIG. 9 displays three-dimensional volumetric renderings of a thick beads phantom, showing fluorescence intensity distribution, according to an embodiment herein. The rendering on the left is obtained using Wide-field Structured Illumination Microscopy (WF-SIM), the middle rendering is from Laser Scanning Confocal Microscopy (LSCM), and the rendering on the right is acquired using Confocal Rescan Structured Illumination Microscopy (CR-SIM). These renderings are created using IMARIS volumetric rendering software and cover a depth range from the surface to 500 micrometres. FIG. 9 offers a comparative visualization of the entire stack of beads phantom, presenting differences in imaging quality and fluorescence intensity distribution among the three microscopy methods.

### B. Cellular Sample Imaging

The effectiveness of the below imaging technique was initially verified by imaging fixed HeLa cells, where F-actin was stained with Texas Red™-X Phalloidin, which emits at a peak of 608 nm. The laser (561 nm) power arriving at the sample surface was <1 mW, and a 60×/1.2 NA OBJ was used. It took 300 ms to acquire three raw images.

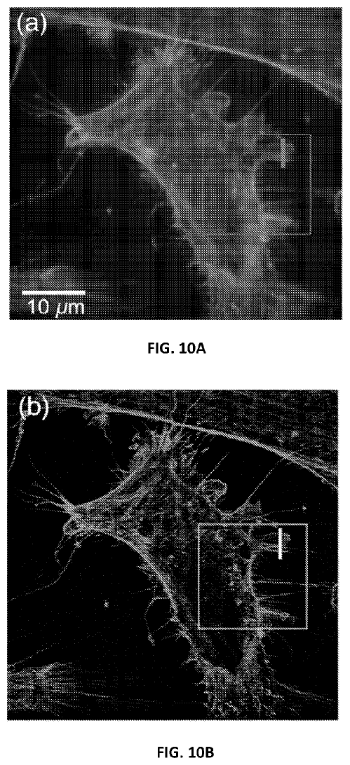

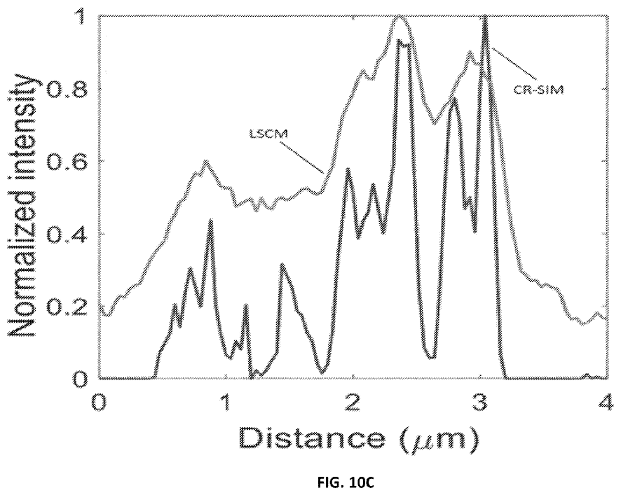

FIG. 10 presents a series of images showcasing the F-actin structures within fixed Hela cells, captured using LSCM and CR-SIM techniques. FIG. 10A is an image capture of fixed HeLa cells identifying F-actin structures using LSCM, according to an embodiment herein. FIG. 10B is an image capture of the same identified F-actin structures within the fixed Hela cells as shown in FIG. 10A, but imaged using CR-SIM, according to an embodiment herein. FIG. 10D is a magnified view of identified regions of interest (ROI) of the F-actin structures in FIG. 10A using LSCM, according to an embodiment herein. FIG. 10E is a magnified view of identified regions of interest (ROI) of the F-actin structures in FIG. 10B using CR-SIM, according to an embodiment herein.

The LSCM image was formed by simply finding the average of three raw images. It included a background component due to the camera's dark current. Although such a homogeneous background could be numerically removed in postprocessing, a certain amount of heterogeneous background manifested itself in the LSCM image, even though the sample was very thin. They should have been caused by the residual out-of-focus light leaking through the slit. The CR-SIM image, on the other hand, was largely free from background contamination. Furthermore, the resolution is isotropically enhanced in comparison with the LSCM image.

FIG. 10C is a graphical representation comparing normalized intensity profiles of the F-actin structures along the identified regions in FIGS. 10A and 10B, according to an embodiment herein. FIG. 10C provides a quantitative assessment of image quality improvement by presenting line profiles obtained along the identified Regions of Interest (ROIs) in FIGS. 10A and 10B.

The LSCM intensity was substantially above zero in the supposedly dark regions. The smallest distance between peaks that could be barely identified in the LSCM profile was 317 nm, which closely matched the diffraction-limited resolution of 309 nm. The CR-SIM profile, in contrast, proved that CR-SIM automatically and efficiently removed all types of background signals. F-actin fibers with a separation of <200 nm could be readily separated, suggesting a resolution enhancement of more than 1.55 times.

### C. Ex Vivo Imaging of GFP Mouse Brain Thick Sections

Super-resolution fluorescence imaging experiments were conducted with thick Thy1-EGFP transgenic mouse brain sections, where neurons were labelled with EGFP. The 473-nm laser and a 40×/1.3NA (UPlanFLN, Olympus) OBJ lens were used to acquire CR-SIM images. The fluorescence emission passed through a bandpass filter centered at 520 nm, and the corresponding diffraction-limited resolution was 244 nm.

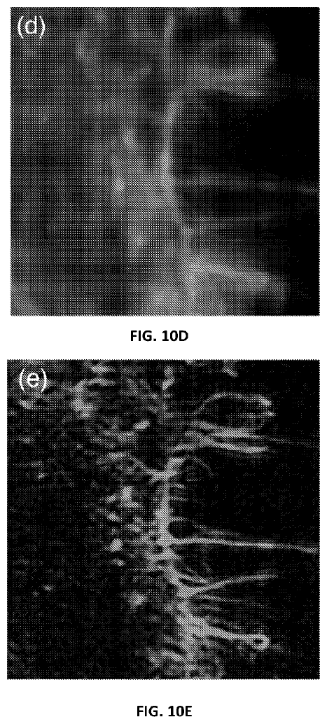

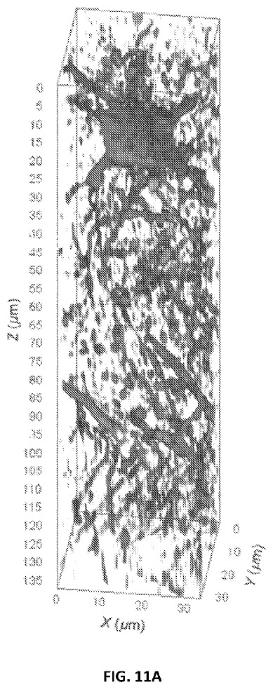

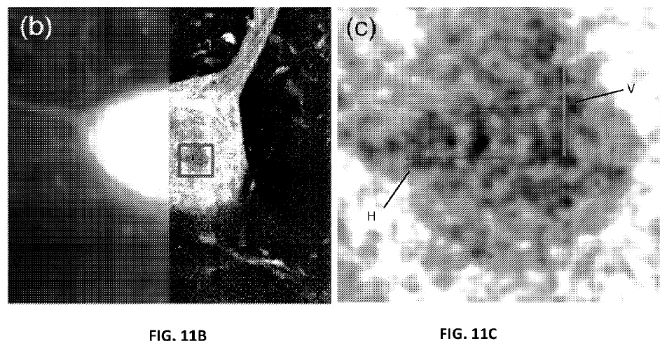

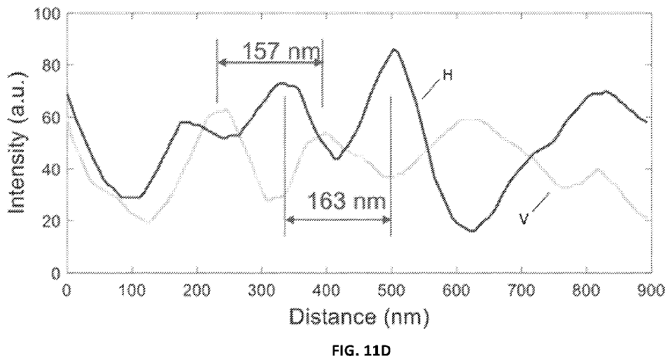

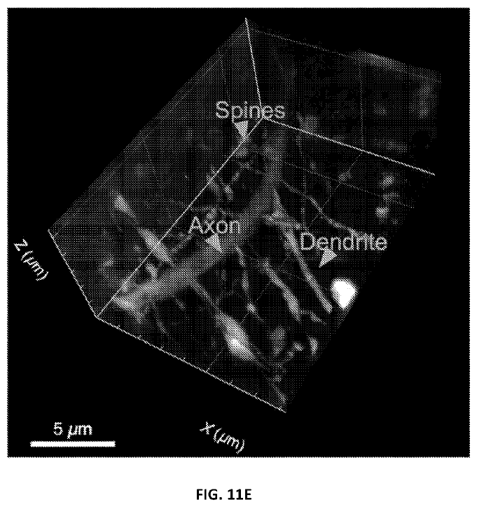

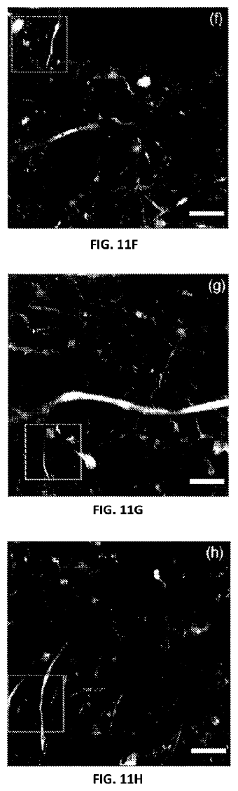

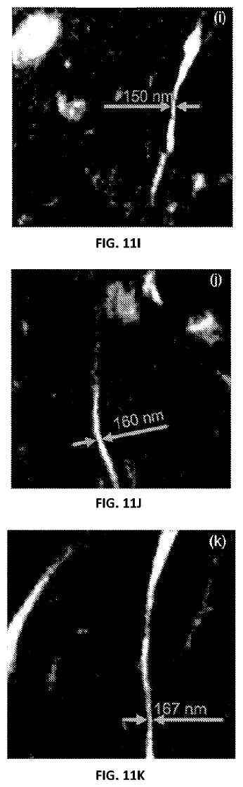

FIG. 11A is a volumetric rendering of a CR-SIM image stack of a Thy1-EGFP transgenic mouse brain slice, according to an embodiment herein. The volumetric rending of FIG. 11A was captured from an imaging region of 33.6 μm×37.8 μm×138 μm (width×height×depth). The depth range was scanned at an increment of 1 μm, resulting in 138 en face image slices.

The exposure time for acquiring one raw image was 100 ms, and in total it took 45 s to complete the 3D volumetric scanning process. A neuron soma, axon segments, and numerous dendrites/dendrite spines were clearly visible with high definition throughout the entire depth range. The fluorescence-labeled structures were densely packed in the space, which would lead to an overwhelming background in WF-SIM images.

FIG. 11B is a comparative image showing a side-by-side visualization of a neuron soma atZ=23 μm using both LSCM (left) and CR-SIM (right) systems, according to an embodiment herein. FIG. 11B is a combination image (LSCM versus CR-SIM) of the neuron soma at Z=23 μm was formed to provide a side-by-side image quality comparison. The background emissions from the sample were so strong that a noticeable number of photons leaked through the slit and compromised the contrast and effective resolution in the LSCM image. On the other hand, CR-SIM provided much richer and more detailed morphological information.

FIG. 11C provides a zoomed-in view of a 2.4 μm×2.4 μm area near the center of the neuron soma, as highlighted within the box in FIG. 11B, and captured using the CR-SIM system. FIG. 11C annotated with labels ‘H’ and ‘V’ to denote specific horizontal and vertical lines, respectively, within the imaged region. FIG. 11D provides a graphical representation of the intensity profiles along these lines. FIG. 11D includes two plots: one corresponding to the horizontal line (labeled ‘H’) and the other to the vertical line (labeled ‘V’) as seen in FIG. 11C. The intensity profiles in FIG. 11D illustrate multiple peaks, approximately 160 nm apart, along both ‘H’ and ‘V’ directions. These peaks indicate a significant enhancement in resolution, more than 1.5 times beyond the conventional diffraction limit, as evidenced in the CR-SIM images.

FIG. 11E is a three-dimensional rendering view of a partial volumetric scan of a mouse brain tissue section, obtained by CR-SIM, according to an embodiment herein. FIG. 11E presents a partial volumetric scan of the tissue stack, illustrates detailed neuronal structures where the connections of axons, dendrites, and spines are visualized in the 3D rendering view.

FIGS. 11F-11H are image captures of neuronal structures within a Thy1-EGFP transgenic mouse brain slice at varying depths of 113 μm (FIG. 11F), 132 μm (FIG. 11G), and 197 μm (FIG. 11H), using the CR-SIM system, according to an embodiment herein. To better illustrate finer structures in these images, some small areas are selected (indicated by the dashed boxes) and further magnified.

FIGS. 11I-11K are image captures corresponding to regions in FIGS. 11F-11H, of the same Thy1-EGFP transgenic mouse brain slice, magnified by a factor of 4, according to an embodiment herein. Relatively thin dendrites with small apparent diameters but a strong SNR were chosen for size estimation. The smallest apparent diameter in each panel in FIGS. 11I-11K was estimated and directly labelled on the image. The medium value of 160 nm was in good agreement with the spatial resolution estimated from FIG. 11D. The thick tissue imaging results provided concrete evidence that CR-SIM was capable of imaging deep into biological tissue with super-resolution and excellent contrast.

### Comments Concerning the Experimental Results

It can be seen that CR-SIM effectively combines structured illumination, image rescan, and confocal detection to achieve remarkable technical breakthroughs in both imaging speed and imaging depth. It can perform high-quality, super-resolved fluorescence imaging in cellular samples as well as in thick tissue. The significantly reduced image acquisition time is highly desirable for capturing fast dynamic biological processes, deferring fading in time-lapse imaging experiments, and minimizing phototoxicity. In addition, the computational load for SIM reconstruction becomes considerably lower. This may enable the real-time rendering of super-resolved images.

Similar to WF-SIM, CR-SIM can achieve a better resolution in the modulation direction by the use of a higher modulation frequency, which was set to the 0.5× resolution limit for ex vivo imaging experiments reported in this paper. The expense will be a lower modulation depth in the modulation pattern and an elevated noise level in reconstructed images. Moreover, the resolution along the image rescan dimension can also be further improved with appropriate deconvolution procedures. The 1.5× enhancement (as noted above in the principle of one-dimensional image re-scan) is estimated based on the full-width at half-maximum of the point spread function. Although the OTF is attenuated more in the high-frequency range, the nonzero bandwidth is still extended to double the diffraction limit. It is, therefore, feasible to reshape the OTF numerically and achieve the maximal resolution enhancement of 2×. In practice, this has to be done carefully to find the optimal compromise between the spatial resolution and the SNR.

The CR-SIM technique notably enhances imaging speed, signal-to-background ratio (SBR), and signal-to-noise ratio (SNR). Using this method, high-quality, super-resolved fluorescence images of EGFP-labeled neuronal structures were successfully captured from mouse brain tissue sections, reaching depths up to 209 μm, surpassing the capabilities of conventional Wide-Field Structured Illumination Microscopy (WF-SIM). These technical improvements position the CR-SIM technique as highly suitable for a broad range of biomedical applications, including studies involving cellular samples and small animal models.

### Sample Preparation

This section outlines the protocols employed in preparing various specimens for imaging. This includes the creation of fluorescent beads phantoms, the preparation of HeLa cell samples, and the careful sectioning of mouse brain tissue, each critical for the subsequent imaging processes.

### Preparation of Fluorescent Beads Phantoms

To characterize the imaging performance of our imaging system, Fluoresbrite® Yellow Green Microspheres from Polysciences were used, which have an excitation maximum at 441 nm and an emission maximum at 486 nm. For quantifying the super-resolution enhancement, we prepared a thin layer of gel mixed with 1 μL 100 nm fluorescent beads (Catalogue No. 17150) and 1 mL 2% agarose solution. Agarose was used to immobilize the beads and also provided a transparent and non-scattering background during imaging. The beads mixture was then vortexed on a vortex mixer, poured into a center well dish (MatTek, P35G-0-10-C), and allowed to stand until solidification for imaging.

For demonstrating imaging performance in thick scattering media, a thick bead phantom was prepared to mimic the scattering properties of biological tissues. In order to increase the signal level in deep regions, large beads (2 μm in diameter) were used in the scattering medium. Because beads with large diameters can allow more surface area for fluorophore to be excited and thus generate more fluorescence photons at the same excitation power¹⁹. We uniformly dispersed 10 μL 2 μm fluorescent beads aqueous suspension (Catalog No. 18140-2) in 40 μL 20% Lipofundin MCT/LCT emulsion (B.Braun Melsungen AG, Germany). Then 350 μL of melted agarose solution was added to the above solution. The total 400 μL solution was pipetted into the well of a single concavity glass microscope slide (1.2-1.3 mm thick) and then sealed with a coverslip using nail polish. The beads phantom thus had a concentration of 2% lipid emulsion and a density of 1137 fluorescent beads per μL. According to the calculation using the Mie theory calculator, the isotropic scattering factor g is about 0.715, and the scattering coefficient μₛ is about 113.3 cm⁻¹, which gives a reduced scattering coefficient of μₛ=(1−g) μₛ=32.3 cm⁻¹. This value is close to the average reduced scattering coefficient of biological tissues.

### Preparation of HeLa Cell Sample

To prepare the live HeLa cell fluorescence slide, we labeled the F-actin of the HeLa cells using Texas Red™-X Phalloidin (Invitrogen). Firstly, Hela cells (ATCC) were cultured in high-glucose Dulbecco's modified Eagle's medium (DMEM) supplemented with 10% fetal bovine serum (FBS), 100 units/mg of penicillin, and 100 μg/ml of streptomycin at 37° C. and 5% CO2. For labeling with Texas Red™-X Phalloidin, Hela cells were seeded on coverslips in 24-well plates at the density of 7×10⁴ cells per well in a 0.5 ml growth medium and allowed to grow for 20~24 h. Next, the cells were washed with 1× PBS three times, followed by fixation with 4% paraformaldehyde and permeabilization with 0.1% Triton X-100. The cells were then stained with phalloidin solution (0.165 mM) for 30 min and washed with PBS. Finally, the coverslip with fixed cells was mounted onto a glass slide with Fluoshield™ (Sigma) and ready for imaging.

### Preparation of Mouse Brain Section

To prepare the mouse brain slice, the Thy1-EGFP transgenic mouse brain was fixed in 4% paraformaldehyde in PBS (w/v) overnight at 4° C. 250-μm vibratome sections were generated by sectioning tissues embedded in 2% agarose with a vibrating microtome (Leica) and permeabilized in 2% TritonX-100 in PBS (v/v) overnight at 4° C. RapiClear 1.52 (SunJin Lab Co), which is a water-soluble clearing reagent for enhanced visualization of biological specimens, was used to clear sections according to the manufacturer's instructions. After 1 hour, the mouse brain slice became transparent and was mounted in an iSpacer microchamber (SunJin Lab Co). The space outside the microchamber was filled with nail polish to ensure a safety seal.

1. A microscopy system comprising:
a light source comprising at least one laser configured to generate a combined light beam;
an optical unit configured to separate the light beam into a plurality of light beams in a focal plane for generating a plurality of illumination patterns, wherein the optical unit comprises at least one of a Wollaston prism, an objective lens, or an electro-optic modulator;
a focusing lens configured to focus the plurality of light beams along a first direction to form a focal line on a sample;
a scanning module comprising one or more scanning mirrors for scanning the focal line across the sample along a second direction and an emission collection mirror for rescanning corresponding fluorescence emissions from the sample;
a confocal slit for filtering out-of-focus light associated with the fluorescence emissions from the sample for providing filtered fluorescence emissions; and
a detection unit for acquiring a plurality of images of the sample corresponding to the filtered fluorescence emissions.

2. The microscopy system of claim 1, further comprising an image processor for reconstructing a high-resolution image representative of a sample based on a combination of a set of captured raw images corresponding to illumination patterns of three phases.

3. The microscopy system of claim 2, wherein the reconstruction of the high-resolution image representative of the sample includes separating frequency components of the raw images, adjusting a rescan ratio along a scanning direction for obtaining one or more reconstructed raw images, and restoring the rescan ratio of the reconstructed raw images along the scanning direction.

4. The microscopy system of claim 2, wherein the reconstruction of the high-resolution image representative of the sample is achieved without rotation of the plurality of the illumination patterns.

5. (canceled)

6. The microscopy system of claim 1, wherein the scanning module is implemented in the form of two galvo mirrors operated in synchronization for the scanning and rescanning of the sample.

7. The microscopy system of claim 1, wherein the optical unit further comprises a retarder for adjusting a polarization component of at least one of the separated light beams for generating the plurality of illumination patterns with adjusted modulation depth.

8. The microscopy system of claim 1, wherein the optical unit further comprises a waveplate for adjusting a polarization distribution of the light beam such that the light beam is suitable for separation into the plurality of light beams.

9. The microscopy system of claim 1, wherein the electro-optic modulator phase shifts a separated light beam relative to another separated light beam.

10. The microscopy system of claim 1, wherein the focusing lens is a cylindrical lens and the first direction is orthogonal to the second direction.

11. The microscopy system of claim 1, wherein the plurality of illumination patterns is generated based on a detected interference between the plurality of separated light beams.

12. (canceled)

13. The microscopy system of claim 1, wherein the Wollaston prism separates the light beam into the plurality of light beams, wherein a separation angle of the Wollaston prism is determined.

14. The microscopy system of claim 13, wherein a modulation frequency corresponding to the Wollaston prism is determined based upon an image resolution and a signal-to-noise ratio.

15. The microscopy system of claim 1, wherein the confocal slit is optically conjugated with the focal line for filtering out-of-focus light.

16. The microscopy system of claim 1, wherein the detection unit comprises a scientific complementary metal-oxide-semiconductor (CMOS) camera that is synchronized with the one or more scanning mirrors and the emission collection mirror for implementing a one-dimensional image rescan.

17. The microscopy system of claim 1, wherein the scanning module is configured to increase an angular velocity of the one or more scanning mirrors relative to the emission collection mirror to achieve a predetermined rescan ratio optimal for resolution enhancement.

18. A light microscopy method comprising:
generating a light beam;
separating the light beam into a plurality of light beams in a focal plane for generating a plurality of illumination patterns;
focusing the plurality of light beams along a first direction to form a focal line on a sample;
scanning the focal line across sample along a second direction and rescanning corresponding fluorescence emissions from the sample;
filtering out-of-focus light associated with the fluorescence emissions from the sample for providing filtered fluorescence emissions; and
acquiring a plurality of images of the sample corresponding to the filtered fluorescence emissions.

19. A method for image reconstruction, comprising:
acquiring a set of raw images corresponding to a plurality of phases of illumination patterns;
applying a Fourier transform (FT) to each of the raw images in the acquired set to obtain a corresponding raw spectrum for each of the raw images;
using an inverse matrix to separate the raw spectrum of each of the raw images into a baseband spectrum and at least two modulation-shifted spectra;
demodulating the set of raw images to generate a demodulated image;
applying a high-pass filter to the baseband spectrum and a low-pass filter to a spectrum of the demodulated image in order to generate a corrected baseband spectrum;
combining the corrected baseband spectrum with the at least two modulation-shifted spectra to generate a synthesized spectrum; and
performing an inverse Fourier transform on the synthesized spectrum to produce a reconstructed image.

20. The method of claim 19 further comprising resizing the reconstructed image to correct for aspect ratio distortion resulting in the reconstructed image having a reduced horizontal dimension.

21-22. (canceled)

23. The method of claim 19, wherein the corrected baseband spectrum is generated by adding the high-pass filtered baseband spectrum to the low-pass filtered spectrum of the demodulated image, wherein the high-pass filter and the low-pass filter use a same predetermined cut-off frequency.

24. The method of claim 19, wherein the demodulated image corresponds to a standard-resolution image and the generated synthetized spectrum comprises a frequency range extended in a vertical direction.

25. (canceled)
